(19) United States
(12) Patent Application Publication
(10) Pub. No.: US 2018/0365070 A1
(43) Pub. Date: Dec. 20, 2018

(54) DYNAMIC THROTTLING OF BROADCASTS IN A TIERED MULTI-NODE SYMMETRIC MULTIPROCESSING COMPUTER SYSTEM

(71) Applicant: International Business Machines Corporation, Armonk, NY (US)

(72) Inventors: Michael A. Blake, Wappingers Falls, NY (US); Mike Chow, Wappingers Falls, NY (US); Kenneth D. Klapproth, Austin, TX (US); Pak-kin Mak, Poughkeepsie, NY (US); Arthur J. O'Neill, JR., Poughkeepsie, NY (US); Robert J. Sonnelitter, III, Wappingers Falls, NY (US)

(21) Appl. No.: 15/625,674

(22) Filed: Jun. 16, 2017

(51) Int. Cl. G06F 9/50; G06F 11/34; G06F 11/30

(52) U.S. Cl. CPC G06F 9/5027; G06F 11/3024; G06F 11/3433; G06F 9/5016

(57) ABSTRACT

Methods, systems, and computer program products for managing broadcasts in a distributed symmetric multiprocessing computer are provided. Aspects include defining a default broadcast rate for a plurality of processors in the distributed symmetric multiprocessing computer, wherein the default broadcast rate is a rate at which a processor broadcasts a request for a resource. The one or more broadcasted requests by a first processor are monitored and related responses are utilized to determine a state of the one or more broadcasted requests. The default broadcast rate is adjusted based at least in part on the state of the one or more broadcasted requests.

### BACKGROUND

The present invention generally relates to data processing, and more specifically, to dynamic throttling of broadcasts in a tiered multi-node symmetric multiprocessing computer system.

Contemporary high performance computer systems are typically implemented as multi-node, symmetric multiprocessing (SMP′) computers with many compute nodes. SMP is a multi-processor computer hardware architecture where two or more, typically many more, identical processors are connected to a single shared main memory and controlled by a single operating system. Most multiprocessor systems today use an SMP architecture. In the case of multi-core processors, the SMP architecture applies to the cores, treating them as separate processors. Processors may be interconnected using buses, crossbar switches, mesh networks, and the like. Each compute node typically includes a number of processors, each of which may have at least some local memory, at least some of which is accelerated with cache memory. The cache memory can be local to each processor, local to a compute node shared across more than one processor, or shared across nodes. All of these architectures require maintenance of cache coherence among the separate caches.

### SUMMARY

Embodiments of the present invention are directed to a computer-implemented method for managing broadcasts in a distributed symmetric multiprocessing computer. A non-limiting example of the computer-implemented method includes defining a default broadcast rate for a plurality of processors in the distributed symmetric multiprocessing computer, wherein the default broadcast rate is a rate at which a processor broadcasts a request for a resource. The one or more broadcasted requests by a first processor are monitored and related responses are utilized to determine a state of the one or more broadcasted requests. The default broadcast rate is adjusted based at least in part on the state of the one or more broadcasted requests.

Embodiments of the present invention are directed to a system for managing broadcasts in a distributed symmetric multiprocessing computer. A non-limiting example of the system includes defining a default broadcast rate for a plurality of processors in the distributed symmetric multiprocessing computer, wherein the default broadcast rate is a rate at which a processor broadcasts a request for a resource. The one or more broadcasted requests by a first processor are monitored and related responses are utilized to determine a state of the one or more broadcasted requests. The default broadcast rate is adjusted based at least in part on the state of the one or more broadcasted requests.

Embodiments of the invention are directed to a computer program product for managing broadcasts in a distributed symmetric multiprocessing computer, the computer program product comprising a computer readable storage medium having program instructions embodied therewith. The program instructions are executable by a processor to cause the processor to perform a method. A non-limiting example of the method includes defining a default broadcast rate for a plurality of processors in the distributed symmetric multiprocessing computer, wherein the default broadcast rate is a rate at which a processor broadcasts a request for a resource. The one or more broadcasted requests by a first processor are monitored and related responses are utilized to determine a state of the one or more broadcasted requests. The default broadcast rate is adjusted based at least in part on the state of the one or more broadcasted requests.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter is particularly pointed out and distinctly claimed in the claims at the conclusion of the specification. The forgoing and other features, and advantages of the embodiments herein are apparent from the following detailed description taken in conjunction with the accompanying drawings in which:

FIG. 1 depicts a block diagram of a distributed symmetric multiprocessing (SMP) system in accordance with one or more embodiments of the invention;

FIG. 2 depicts a block diagram of a drawer in a distributed symmetric multiprocessing (SMP) system in accordance with one or more embodiments of the invention;

FIG. 3 depicts a block diagram of an exemplary symmetric multiprocessor (SMP) computer according to one or more embodiments of the invention;

FIG. 4 depicts a coherence establishment and data processing sequence in a cache coherence protocol according to one or more embodiments of the invention;

FIG. 5 depicts an illustrative example of a status table of broadcasts states for a processor according to one or more embodiments of the invention;

FIG. 6 depicts an illustrative example of a status table of broadcasts states for a processor according to one or more embodiments of the invention; and

FIG. 7 depicts a flow diagram of a method for managing broadcasted coherency requests in a distributed symmetric multiprocessing computer according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, are symmetric multiprocessor computing systems that utilize bus snooping for cache coherency. Cache coherence defines the behavior of reads and writes to a same memory location. The cache coherency occurs if the following conditions are met.

In a read made by a processor P to a location X that follows a write by the same processor P to X, with no writes of X by another processor occurring between the write and the read instructions made by P, X must always return the value written by P. This condition is related to the program order preservation, and this must be achieved even in mono-processer architectures.

Condition 1. A read made by a processor P1 to location X that happens after a write by another processor P2 to X must return the written value made by P2 if no other writes to X made by any processor occur between the two accesses and the read and write are sufficiently separated. This condition defines the concept of a coherent view of memory. If processors can read the same old value after the write made by P2, we can say that the memory is incoherent.

Condition 2. Writes to the same location must be sequenced. In other words, if location X received two different values A and B, in this order, from any two processors, the processors can never read location X as B and then read it as A. The location X must be seen with values A and B in that order.

These conditions are defined supposing that the read and write operations are made instantaneously. However, this doesn't happen in computer hardware given memory latency and other aspects of the architecture. A write by processor P1 may not be seen by a read from processor P2 if the read is made within a very small time after the write has been made. The memory consistency model defines when a written value must be seen by the following read instruction made by the other processors.

Snooping is a process where the individual caches monitor address lines for accesses to memory locations that they have cached. It is called a write invalidate protocol when a write operation is observed to a location that a cache has a copy of and the cache controller invalidates its own copy of the snooped memory location.

In a multi-tiered symmetric multiprocessor (SMP) system operations with coherency requests are broadcast to adjacent chips which can, in turn, be rejected by conflicting global operations that have already established coherency or rejected due to resource constraints. A proposed solution was to re-broadcast the request as quickly as possible to try to establish the coherency on the chip acting as the point of coherency for the local operation. This can have the negative effect of overwhelming the pipeline on the chip handling the coherency/global and local interlocks causing operations that could otherwise or should otherwise be making process to have limited pipeline resources to be used.

Some other proposed solutions utilize a fixed coherency request broadcasting and re-broadcasting rate which limits the number of times a chip can send broadcasts to other chips in the SMP in a given period of time. By fixing the broadcast rate, the cache pipeline is prevented from being overrun by received coherency requests. However, this setup has the negative effect of limiting the number of broadcasting coherency request events despite potentially low utilization of the pipeline at the time of broadcasts and re-broadcasts.

Turning now to an overview of the aspects of the invention, one or more embodiments of the invention address the above-described shortcomings of the prior art by providing dynamic throttling of coherency request broadcasts in an SMP computer system. The present invention seeks to address the issues described above by limiting the broadcasting and/or the re-broadcasting of coherency request operations based on either the number of outstanding coherency request operations to the set of resources acting as the point of coherency or the number of rejects that have been issued by the point of coherency. Essentially, a programmable operations state threshold for a processor can trigger a throttling of the coherency request broadcast rate for a chip/controller in the SMP. Also, either the same or another programmable operations state threshold, once met, causes the requesting cache controller to remove the throttling and re-institutes the initial broadcast rate. Additionally, pipeline throughput is increased by allowing a storage controller (point of coherency) to avoid being bogged down with broadcast requests based on the pre-programmed threshold.

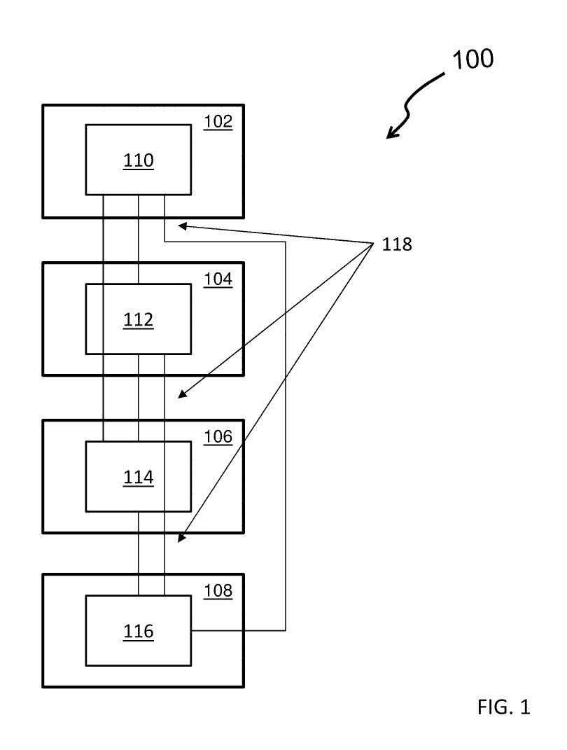

Turning now to a more detailed description of aspects of the present invention, FIG. 1 depicts a distributed symmetric multiprocessing (SMP) system 100 (hereafter “system 100”) in accordance with one or more embodiments.

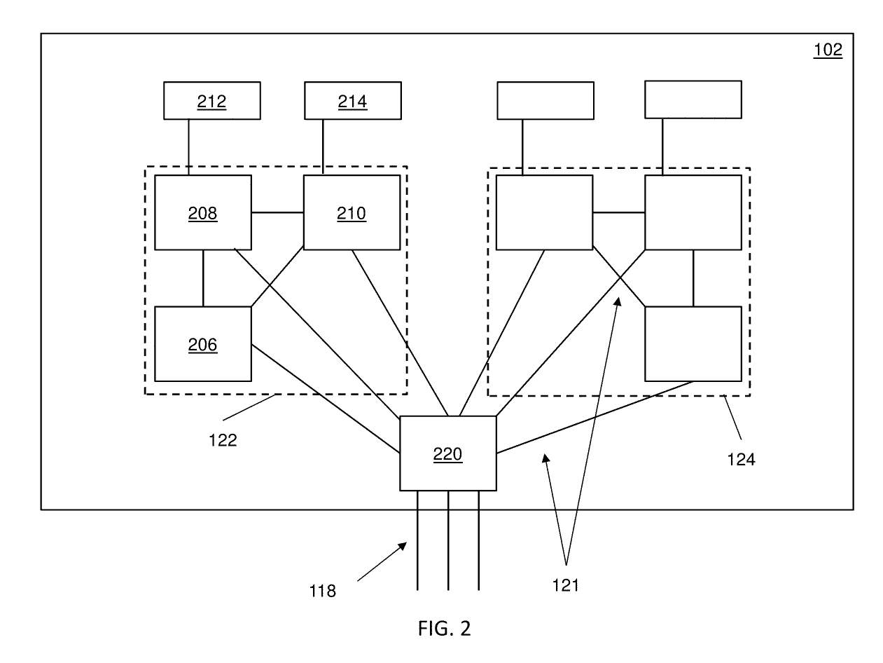

FIG. 1 depicts a distributed symmetric multiprocessing (SMP) system 100 (hereafter “system 100”) in accordance with one or more embodiments. System 100 can include 4 processing units or “drawers.” Drawer 102 (described in greater detail with respect to FIG. 2) connects to drawer 104, drawer 106, and drawer 108 via a storage controller (SC) chip 110. Drawers 104, 106, and 108 each have a respected SC chip (e.g., SC chip 112, SC chip 114, SC chip 116). Bus lines 118 connect drawers 102, 104, 106, and 108. Intra-drawer coherency communication may be performed using pass-through and a combination of these bus-lines, 118.

In an embodiment, cache lines that are owned or shared by processors of an entity at a level of coherency (cluster, CP Chip, drawer) are candidates to be handled at the level of coherency. Thus, if a processor of the entity requests ownership or sharing of a line that is already owned by a processor of the same entity (e.g., CP Chip or drawer), the entity need not access other entities to handle the request coherently. A request, for example, by a processor of a CP chip within a CP cluster, for sharing of a cache line is examined by storage controller (SC) function to determine if the line is owned or shared by a processor of CP cluster. If it is already owned or shared, the SC handles the request within the CP cluster without accessing any other CP clusters. If the line is neither owned nor shared by a processor of CP cluster, the SC of the initial CP Cluster performs a cache coherency operation with the other CP chips on the other CP clusters connected to that SC chip or on the other drawers via the SC chips on those drawers.

FIG. 2 depicts drawer 102 in greater detail, according to one or more embodiments. Although FIG. 2 depicts only drawer 102, it should be appreciated that a similar configuration is contemplated for drawers 104, 106, and 108, and/or other drawers in system 100. Referring now to FIG. 2, drawer 102 includes two central processor (CP) clusters 122 and 124. A cluster includes three central processor (CP) chips operatively connected to a storage controller (SC) chip 220 and connected to the other CP chips within the same cluster. For example, CP cluster 122 includes CP chip 206, CP chip 208, and CP chip 210. Each respective CP chip may be connected to a system memory (e.g., system memory 212 and system memory 214). CP chip 122 is operatively connected with each of the other clusters (e.g., 124) via bus lines 121 through the storage controller 220. In other aspects, a CP cluster may include any number of CP chips, although embodiments are described as having only three.

The storage controller (SC) 220 can be a logic circuit that manages cache memory, providing an interface among processors, caches, and main memory. Although the storage controller 220 is represented externally to the CP chips (206, 208, 210), storage controllers can be integrated directly into the CP chips.

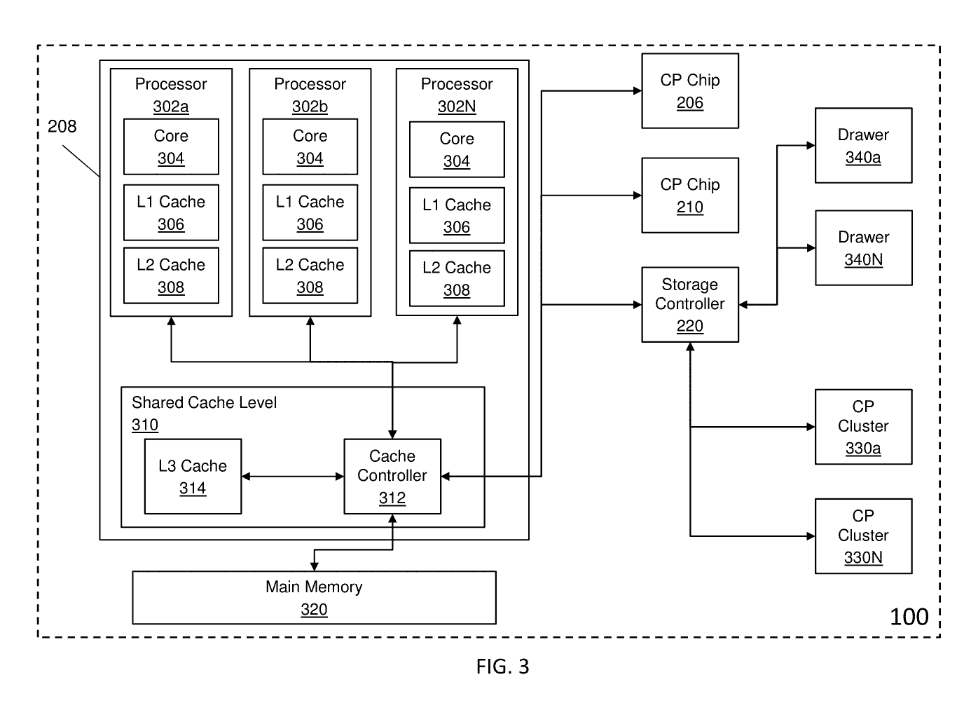

FIG. 3 depicts a block diagram of an exemplary symmetric multiprocessor (SMP) computer according to one or more embodiments of the present invention. The system 100 includes several CP clusters 330a-330N (where N is any whole number greater than 2) which may be directly connected or connected through other storage controllers. As described in FIG. 2, each CP cluster includes three CP chips. CP chip 208 is depicted in greater detail in FIG. 3. CP chip 208 includes processors 302a-302N (where N is any whole number greater than 2). Each processor has one or more cores 304, an L1 cache 306, and an L2 cache 308. Each processor within the CP chip 208 is communicative coupled to a cache controller 312 on a shared cache level 310. The cache controller 312 can access the L3 cache 314. In one or more embodiments, each of the processors 302a-302N share the L3 cache on the CP chip 208. The cache controller 312 with the L3 cache implements a shared cache level 310 across the CP clusters (330a-330N) in the system 100.

The main memory 320 can include a random access store of program data and program instructions for data processing on the system 100. Main memory 320 is characterized by memory latency, the time required for a memory access, a read or write to or from main memory.

The L1 cache 306 and L2 cache 308 along with the L3 cache 314 are specialized segments of memory used by the processors 302a-302N to reduce memory access latency. Each cache is smaller and faster than main memory 320, and each cache stores copies of data from frequently used main memory locations. When a processor needs to read from or write to a location in memory, it first checks whether a copy of that data, a “cache line,” is in a cache.

In the examples of FIG. 3, when a processor 302a on CP chip 208 in CP cluster 122 experiences a cache miss for a cache line in the L3 cache 314, which of course follows a cache miss on L1 306 and L2 308, the cache controller 312 broadcasts to the other CP chips 206, 210 and the storage controller 220 a coherency request for the cache line. The storage controller 220 checks its L4 cache and if necessary also looks to the other CP clusters 330a . . . 330N and the other drawers 340a . . . 340N check for the cache line in their respective L3 and L4 cache. If either of the CP chips 206, 210 or the storage controller 220 does have the line it will be returned from one of these locations. If neither the other CP chips 206, 210 or the storage controller 220 have the cache line, the storage controller 220 requests the cache line from the other cache levels on other clusters or drawers that does have it. At this point in processing, if the storage controller 220 cannot retrieve the cache line from the other Drawer 340a . . . 330N or CP Cluster 330a . . . 330N, it would be forced to retrieve the cache line from main memory, a very undesirable result in terms of memory latency. Responsive to receiving the broadcast coherency request within a cluster, each of the other CP chips (206, 210) transmits to all other CP Chips the state of the cache line on that CP cluster. If at least one of the CP Chips that received the broadcast request has a correct copy of the cache line, that CP Chip also transmits to the CP chip 208 that issued the broadcast request, the correct copy of the cache line. In the above description, the CP Chip broadcasting the request is utilizing the cache controller 312 for coherency operations. For ease of illustration, the CP chip is referenced.

Each CP chip then updates the state of the cache line in that CP chip, in dependence upon one or more of the states of the cache line in all the CP Chips. “Update” in this context means confirming that the current cache line state is correct in view of the information received from all the other CP Chips—regardless whether the state changes. Updating, therefore, may not require a change in a cache line state on any particular CP Chip. If for example, a CP Chip that received the broadcast, in the context of a READ memory operation, had a correct copy of a cache line in SHARED state, that CP Chip would transmit the cache line to the CP Chip that issued the broadcast request, but the SHARED state would remain unchanged in the updating confirmation of the cache line state in that CP Chip. If for a further example, a CP Chip that received the broadcast, in the context of a WRITE memory operations, had a correct copy of a cache line in SHARED state, that CP Chip would transmit the cache line to the CP Chip that issued the broadcast request, but the SHARED state would change to INVALID in the updating of the cache line state.

Upon obtaining a correct copy of the cache line, the CP Chip 208 that issued the coherency request releases the cache line for subsequent memory operations. There are two ways to obtain the correct copy of the cache line. If the CP Chip 208 that issued the coherency request does not receive a correct copy in response to the coherency request, the storage controller obtains a correct copy of the cache line by retrieving the contents of the cache line from main memory experiencing substantially higher latency. If at least one of the other CP clusters 330a . . . 330N or drawers 340a . . . 340N that received the broadcast request has a correct copy of the cache line when it receives the coherency request, that CP cluster or drawer transmits to the broadcasting CP Chip 208 the correct copy of the cache line—thereby avoiding the main memory access and the substantially higher latency incurred by this event. Before the CP chip 208 that issued the coherency request is enabled to issue another broadcast request for the same cache line, the other CP chips 206, 210, CP Clusters, 330a . . . 330N, and drawers 340a . . . 340N that received the broadcast request confirm to the CP Chip 208 that issued the broadcast request that all the other CP Chips that received the broadcast have completed the updating of the state of the cache line in each chip.

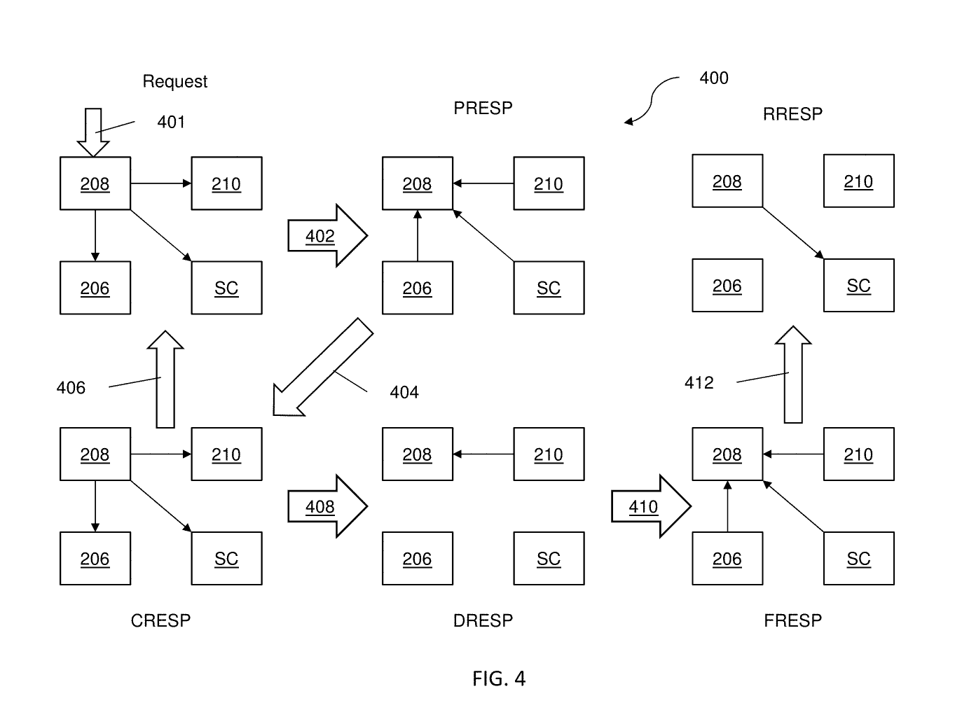

For further explanation, FIG. 4 illustrates a coherence establishment and data processing sequence in a cache coherence protocol according to one or more embodiments of the present invention. As shown in FIG. 4, the data processing sequence has several phases, namely a coherency request (or Broadcast) phase, a partial response (PRESP) phase, and a combined response (CRESP) phase. These three phases preferably occur in the foregoing order and do not overlap. The operation also has a data response phase (DRESP), which may optionally overlap with any of the request, partial response, and combined response phases. The coherency request phase begins when a CP Chip 208 experiences an event such as, for example, a cache miss 401 in its L3 cache for a cache line. The CP Chip 208 broadcasts a coherency request for a resource such as, for example, a cache line to each of the other CP Chips (206, 210) in a CP Cluster such as CP Cluster 122 from FIG. 2. The broadcast is also sent to SC 220 during the broadcast phase. The SC is communicatively coupled to each of the CP Chips in CP Cluster 122 as well as the CP Chips in other clusters (e.g., CP Cluster 124 of FIG. 2, etc.) and storage controllers on other drawers that themselves may be connected to other CP clusters. Step 402 moves this sequence to the partial response (PRESP) phase where each of the CP Chips 206, 210 and the SC send a response back to the broadcasting CP Chip 208. The response includes a state of the cache line being requested. When all CP Chips 206, 210 and the SC send a response 404, the sequence moves to the combined response (CRESP) phase. At the CRESP phase, the PRESPs are combined together and the coherency protocol decides how to handle the response. If at least one of the CP Chips returns a hit for the cache line and no rejects are seen, this is considered a clean sequence and at step 408, the sequence moves to a data response (DRESP) phase. At the DRESP phase, one of the CP Chips (210) sends the data to the requesting CP Chip 208. Although the illustrative example shows CP Chip 210 as sending the data, any of the CP Chips 206 & SC could send the data to the requesting CP Chip 208. In the illustrative example, the broadcasted coherency request is sent to two CP Chips 206, 210 in the CP Cluster 122 and the storage controller (SC). The storage controller in this case is located on the drawer 102 from FIG. 1. The storage controller has an L4 cache that is accessed before looking to other CP Clusters (e.g., 303a . . . 303N) for the cache lines. The other drawers 340a . . . 340N may check their own storage controllers and clusters for the cache line if necessary as well. If the cache line is not present in the L4 cache or any of the caches of the other CP Clusters or drawers, the line can be accessed from a main memory and sent to the broadcasting CP Chip 208. At step 410 the sequence moves to the final response (FRESP) phase where each CP Chip 206, 210 and the SC essentially inform the broadcasting CP Chip 208 that the response is complete. Step 412 moves the sequence to the reset response (RRESP) phase where the broadcasting CP Chip 208 informs the storage controller (SC) that the operation is complete. The above sequence describes a clean sequence when it progresses to step 408. However, at step 406, the combined response (CRESP) may send a reject back to the broadcasting CP Chip 208. A reject occurs if one of the other CP Chips or SC chip (or any processors within the CP Chip) is utilizing or accessing the line (i.e., an address conflict) or, in some cases, the resource could not be accessed. When a rejection is sent to the broadcasting CP Chip 208, the cache controller 312 typically would re-broadcast out the coherency request immediately. This has the added effect of overloading the storage controller as the storage controller might be handling a large number of coherency requests from the other CP Chips in the CP Cluster 122 or adjacent cluster 124 in the drawer 102. The storage controller might also be receiving broadcasts from the other storage controllers in the other drawers 104, 106, 108 in the SMP.

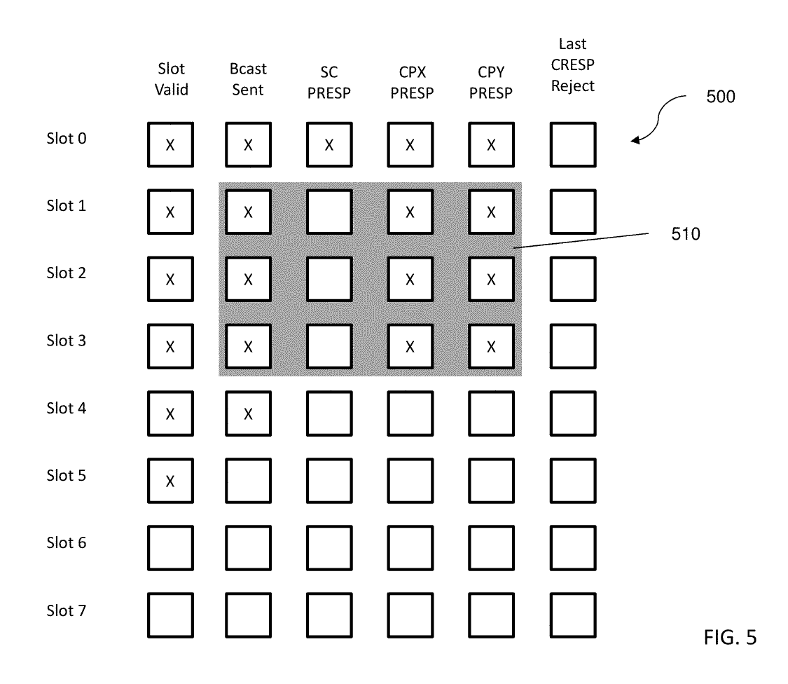

In one or more embodiments, the first three response phases can be monitored for each of the CP Chips and each broadcasted coherency request made by the CP Chips. A CP Chip could send out multiple coherency requests based on its utilization and the need for requesting resources. FIG. 5 depicts a status table of states for a broadcasted coherency request from CP Chip according to one or more embodiments of the present invention. The tracking graph 500 includes 8 slots marked as slot 0 through slot 7. Each slot represents an operation of a CP Chip in a CP Cluster. As earlier depicted in FIG. 2, each CP Cluster includes three CP Chips and a storage controller. For ease of illustration, the slots depicted in FIG. 5 are operations for CP Chip 208 in CP Cluster 122. The columns for the status table 500 include Slot Valid, Bcast (broadcast) Sent, SC PRESP, CPX PRESP, CPY PRESP, and Last CRESP Reject. The boxes marked with an X indicated a true value for the associated column for the operation in the slot. For example, Slot 0 indicates that the Slot is valid, that the coherency request has been broadcast for this operation, the storage controller has sent its partial response, CP Chip X (i.e., 206) has sent its partial response, CP Chip Y (i.e., 210) has sent is partial response, and there has not be a rejection sent as the combined response. (Note, if the broadcasted coherency request originates from a different CP Chip such as CP Chip 206, then CP Chip X and CP Chip Y will be 208 and 210.) Thus, for the operation of Slot 0, the operation has moved to at least the DRESP phase of the sequence depicted in FIG. 4. The column mark slot valid, when marked with an X, indicates that an event has occurred that necessitates a broadcast/re-broadcast of a coherency request such as, for example, a cache miss, cache hit in a shared state (for an exclusive fetch), or a reject combined response. A broadcasted coherency request is determined to be needed based on the type of operation which will have a desired end cache state and the hit or miss state of the line in the cache level such as the L3 that is being queried. The hit or miss state is done through a lookup of a directory which contains a mapping of cache entries/slots that could contain a cache line to the actual address of the cache line stored in that slot. The directory also contains the ownership state of the cache line address stored in the slot. With each requesting operation in the cache this directory is queried to determine if the line exists in one of the cache slots and if it does what the state of the line is. This information is used to either service the original request or create a new coherency request which will be broadcast to the other chips and drawers/clusters if necessary to do the cache lookup in those locations.

In one or more embodiments, each CP Chip in an SMP has a default broadcast rate that determines when and how often a CP Chip can broadcast a request for a resource to the other CP Chips within a cluster and storage controllers. A CP Chip may send multiple broadcasts and have the responses be in various states as illustrated in the status table 500. As responses are sent and received their corresponding slot on the status table 500 are updated accordingly. In the illustrated example (FIG. 5), a pre-defined threshold 510 is defined. The status of the requests in the status table 500 is compared to the pre-defined threshold and if met or exceeded, the broadcast rate is adjusted. This adjustment to the broadcast rate can be specific to the CP Chip for the status table 500 or for any CP Chip in the SMP. The adjustment to the broadcast rate can be a decrease in the frequency at which broadcasts or can be blocking all broadcasts until the status graph 500 no longer has the pre-defined threshold state 510.

In the illustrated example, the pre-defined threshold defines a state where the storage controller has not sent a partial response for three operations that have been broadcast to the chips in the cluster. This state might indicate that the SC pipeline that is targeted is overwhelmed by broadcasted coherency requests. Adjusting the broadcast rate has the benefit of allowing the SC pipeline to catch up with the broadcasts being sent. For example, the three broadcasts for Slot 1-3 could require the SC to access the same resource within the SC chip that several broadcasted coherency requests from other sources may also be trying to access at the same time

In one or more embodiments of the present invention, a second pre-defined threshold can be defined that when compared to the status table 500 would indicate that the broadcast rate can be restored to the default broadcast rate. The second pre-defined threshold can be anything less than the initial threshold that caused the adjustment to the broadcast rate or could be when the operations causing the adjustment are completed. In the exemplary case, an operation is completed when the operation sequence moves to the data response phase as described in FIG. 4.

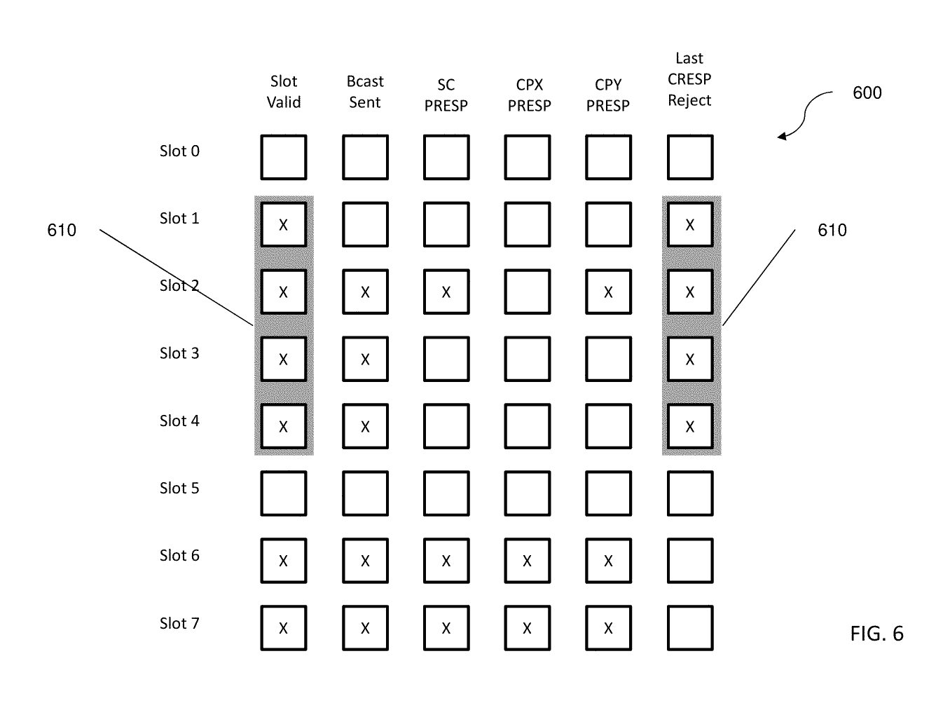

FIG. 6 depicts a status table of broadcast states for a CP Chip according to one or more embodiments of the present invention. The status table 600 includes Slots 0-7 depicts the state of an operation. Slot 1-4 each have slot valid indication as well as CRESP reject as the last response received. After a CRESP rejection, the CP Chip will immediately rebroadcast a request for a resource. Multiple rejections, as indicated in Slots 1-4 may indicate some resource limitations on a target chip or address conflicts depending on a design point. When the rejected operations indication (i.e., Last CRESP Reject column) reaches a pre-defined threshold 610 of broadcasts and the status of responses, the CP Chip default broadcast rate can be adjusted until the condition is no longer present in the status table or the status table has a number of CRESP rejects that falls below a different, pre-defined threshold value. While the illustrative example shows the adjustment to the broadcast rate being performed when the number CRESP rejections occur, one of ordinary skill in the art can utilize any combination of the status of responses to the broadcast. For example, if 10 broadcasts have CRESP rejections, the broadcast rate and be throttled based on this number of rejection. Or, if 25 broadcasts are waiting on a response from the storage controller, the broadcast rate can be throttled. Additionally, in one or more embodiments, the broadcast rate can be increased based on any combination of the different states of broadcasts as shown in the status table 600. Additionally, the columns of the status table 600 can be expanded or reduced based on the resource needs and/or limitations of the system 100.

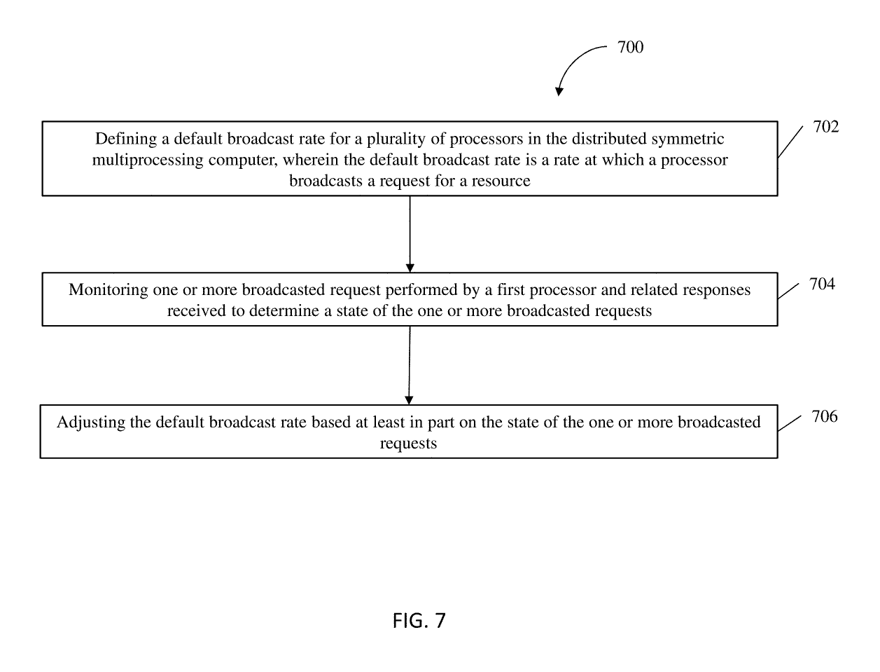

FIG. 7 depicts a flow diagram of a method for data entry security according to one or more embodiments of the invention. The method 700 includes defining a default broadcast rate for a plurality of CP Chips in the distributed symmetric multiprocessing computer, wherein the default broadcast rate is a rate at which a CP Chip broadcasts a request for a resource, as shown at block 702. At block 704, the method 700 includes monitoring one or more broadcasts performed by a first CP Chip to determine a state of the one or more broadcasts. And at block 706, the method 700 includes adjusting the default broadcast rate based at least in part on the state of the one or more broadcasts.

Additional processes may also be included. It should be understood that the processes depicted in FIG. 7 represent illustrations and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing broadcasted coherency requests in a distributed symmetric multiprocessing computer, the method comprising:
defining a default broadcast rate for a plurality of processors in the distributed symmetric multiprocessing computer, wherein the default broadcast rate is a rate at which a processor broadcasts a request for a resource;
monitoring one or more broadcasted requests performed by a first processor and related responses received to determine a state of the one or more broadcasted requests; and
adjusting the default broadcast rate based at least in part on the state of the one or more broadcasted requests.

2. The method of claim 1, wherein the state of the one or more broadcasted requests includes a status of one or more pending responses to the one or more broadcasted requests; and
wherein the adjusting the default broadcast rate comprises decreasing the default broadcast rate based at least in part on a number of the one or more pending responses exceeding a first threshold.

3. The method of claim 2, further comprising:
restoring the default broadcast rate based at least in part on the number of the one or more pending responses being below the first threshold.

4. The method of claim 2, further comprising:
restoring the default broadcast rate based at least in part on the number of the one or more pending responses being below a second threshold.

5. The method of claim 1, wherein the resource comprises a cache line in a cache of a different processor in the plurality of processors.

6. The method of claim 5, wherein the cache of the different processor is an L3 cache.

7. The method of claim 1, wherein the one or more broadcasted requests are responsive to an event.

8. The method of claim 7, wherein the event is a cache miss by the first processor.

9. A system for managing broadcasted requests in a distributed symmetric multiprocessing computer, the system comprising:
a set of one or more drawers including a plurality of central processor (CP) clusters, wherein each CP cluster is communicatively coupled by a respective bus within a respective drawer of the set of one or more drawers;
and wherein each CP cluster in the plurality of CP clusters comprises a plurality of processors, at least one storage controller, and a cache controller, the cache controller configured to:
define a default broadcast rate for a plurality of processors in the distributed symmetric multiprocessing computer, wherein the default broadcast rate is a rate at which a processor broadcasts a request for a resource;
monitor one or more broadcasted requests performed by a first processor and related responses received to determine a state of the one or more broadcasted requests; and
adjust the default broadcast rate based at least in part on the state of the one or more broadcasted requests.

10. The system of claim 9, wherein the state of the one or more broadcasted requests includes a status of one or more pending responses to the one or more broadcasted requests; and
wherein adjusting the default broadcast rate comprises decreasing the default broadcast rate based at least in part on a number of the one or more pending responses exceeding a first threshold.

11. The system of claim 10, wherein the cache coherency protocol is further configured to:
restore the default broadcast rate based at least in part on the number of the one or more pending responses being below the first threshold.

12. The system of claim 10, wherein the cache coherency protocol is further configured to:
restore the default broadcast rate based at least in part on the number of the one or more pending responses being below a second threshold.

13. The system of claim 9, wherein the resource comprises a cache line in a cache of a different processor in the plurality of processors.

14. The system of claim 13, wherein the cache of the different processor is an L3 cache.

15. A computer program product for managing broadcasted coherency requests in a distributed symmetric multiprocessing computer comprising a computer readable storage medium having program instructions embodied therewith, the program instructions executable by a processor to cause the processor to perform a method comprising:
defining a default broadcast rate for a plurality of processors in the distributed symmetric multiprocessing computer, wherein the default broadcast rate is a rate at which a processor broadcasts a request for a resource;
monitoring one or more broadcasted requests performed by a first processor and related responses received to determine a state of the one or more broadcasted requests; and
adjusting the default broadcast rate based at least in part on the state of the one or more broadcasted requests.

16. The computer program product of claim 15, wherein the state of the one or more broadcasted requests includes a status of one or more pending responses to the one or more broadcasted requests; and
wherein the adjusting the default broadcast rate comprises decreasing the default broadcast rate based at least in part on a number of the one or more pending responses exceeding a first threshold.

17. The computer program product of claim 16, further comprising:
restoring the default broadcast rate based at least in part on the number of the one or more pending responses being below the first threshold.

18. The computer program product of claim 16, further comprising:
restoring the default broadcast rate based at least in part on the number of the one or more pending responses being below a second threshold.

19. The computer program product of claim 15, wherein the resource comprises a cache line in a cache of a different processor in the plurality of processors.

20. The computer program product of claim 19, wherein the cache of the different processor is an L3 cache.
